(19) United States
(12) Patent Application Publication
(10) Pub. No.: US 2026/0320872 A1
(43) Pub. Date: Oct. 15, 2026

(54) METHOD AND APPARATUS FOR MANAGEMENT OF DIGITAL DESIGN DATA

(71) Applicant: CLO VIRTUAL FASHION INC., Seoul (KR)

(72) Inventors: Tae Wan JEONG, Seoul (KR); Joo Seok LEE, Seoul (KR); Hong Hyun AHN, Seoul (KR); Seong Joon LEE, Seoul (KR); Ye Ji KIM, Seoul (KR)

(21) Appl. No.: 19/690,146

(22) Filed: May 28, 2026

Related U.S. Application Data
(63) Continuation of application No. PCT/KR2025/008732, filed on Jun. 23, 2025.

(30) Foreign Application Priority Data
Jun. 21, 2024 (KR) 10-2024-0081146
Dec. 20, 2024 (KR) 10-2024-0193174
Jun. 23, 2025 (KR) 10-2025-0082971

(51) Int. Cl. G06T 11/60; A41H 3/00; G06F 3/0484

(52) U.S. Cl. CPC G06T 11/60; A41H 3/007; G06F 3/0484; G06T 2200/24; G06T 2210/16

(57) ABSTRACT

A method of managing a digital design item is provided. The method includes obtaining a first attribute information set corresponding to a first element set associated with a first style of the design item, the design item including at least one component, obtaining a second attribute information set corresponding to a second element set associated with each of at least one second style of the design item, in which each of the first element set and the second element set includes a first element, and each of the first attribute information set and the second attribute information set includes first attribute information of the first element, and in response to user input to change the first attribute information to second attribute information in the first attribute information set, obtaining a third style corresponding to the first style of the design item.

### CROSS-REFERENCE TO RELATED APPLICATIONS

This is a bypass continuation of International PCT Application No. PCT/KR2025/008732, filed on Jun. 23, 2025, which claims priority to Republic of Korea Patent Application No. 10-2024-0081146, filed on Jun. 21, 2024, Republic of Korea Patent Application No. 10-2024-0193174, filed on Dec. 20, 2024, and Republic of Korea Patent Application No. 10-2025-0082971, filed on Jun. 23, 2025, which are incorporated by reference herein in their entirety.

### TECHNICAL FIELD

The following embodiments relate to a method and apparatus for managing digital design data.

### BACKGROUND ART

Garments may be expressed in various forms depending on the characteristics of fabric and style. Trends in garments may vary over time and across regions. Although trends are important for the design, development, and marketing of new garments, applying trends directly to each part of a plurality of garments for each design may require significant time and effort from workers. A “colorway” may be used to reflect trends and/or to perform style transformations. The term “colorway” may refer to a set of garments having the same design but different color combinations applied, that is, a set of garments sharing the same design but differing in color. A user may determine an optimal color combination by easily visualizing and comparing various color combinations or color options through colorways.

The above description is information the inventor(s) acquired during the course of conceiving the present disclosure, or already possessed at the time, and was not necessarily publicly known before the present application was filed.

### SUMMARY

An aspect provides a method of managing a digital design item. The method includes obtaining a first attribute information set corresponding to a first element set associated with a first style of the design item, the design item including at least one component, obtaining a second attribute information set corresponding to a second element set associated with each of at least one second style of the design item, in which each of the first element set and the second element set includes a first element and each of the first attribute information set and the second attribute information set includes first attribute information of the first element, and in response to user input to change the first attribute information to second attribute information in the first attribute information set, obtaining a third style corresponding to the first style of the design item.

The first attribute information and the second attribute information may include first sub-attribute information corresponding to a physical attribute and second sub-attribute information corresponding to a visual attribute.

The user input to change the first attribute information to the second attribute information may be controlled such that second attribute information in which only the second sub-attribute information of the first attribute information is changed is input.

The user input to change the first attribute information to the second attribute information may be controlled such that second attribute information in which at least one of the first sub-attribute information and the second sub-attribute information of the first attribute information is changed is input.

The obtaining of the third style may include, in response to the user input, obtaining at least one fourth style corresponding to the at least one second style by applying the second attribute information to the first element of the second element set.

The method may include generating at least one collection element corresponding to at least some of a plurality of elements included in the first element set and in at least one second element set associated with the at least one second style. Each of the at least one collection element may correspond to at least one piece of first sub-attribute information and a plurality of second sub-attribute information.

The generating of the at least one collection element may include grouping the plurality of elements into at least one element group based on a condition related to common first sub-attribute information, and generating, for each of the at least one element group, a collection element corresponding to the common first sub-attribute information and to a plurality of second sub-attribute information associated with the element group. The method may further include receiving a selection input corresponding to at least some of the plurality of elements, and the generating of the at least one collection element may include generating a collection element corresponding to first sub-attribute information of a selected element and to a plurality of second sub-attribute information corresponding to at least some of the plurality of elements in response to user input to select the selected element.

The method may further include replacing each of at least some of the plurality of elements with a corresponding collection element.

The replacing may include identifying second sub-attribute information of each of at least some of the plurality of elements and replacing the corresponding element with a collection element to which the identified second sub-attribute information is applied.

The replacing may not be performed if the corresponding collection element is generated based on a plurality of elements included in a single element set. The method may include receiving a default style of the design item including at least one component, obtaining a default attribute information set of at least one default element set corresponding to the at least one component, and generating at least one generation style of the design item including a generation element set of a generative attribute information set based on at least some of the default attribute information set. The first style and the at least one second style may correspond to the default style or the at least one generation style.

Each of at least one piece of generative attribute information included in the generative attribute information set may correspond to one of first generative attribute information including first sub-attribute information of the default attribute information and second sub-attribute information that is different from second sub-attribute information of the default attribute information, second generative attribute information including first sub-attribute information and second sub-attribute information that are independently configurable from the default attribute information, and third generative attribute information corresponding to the default attribute information.

The third generative attribute information may have a first change applied when there is a first change in the default attribute information, and the default attribute information may have a second change applied when there is a second change in the third generative attribute information.

The method may further include loading an attribute information list corresponding to each of a plurality of elements included in the first element set and in the second element set and providing at least one piece of attribute information included in the attribute information list.

The design item may include a component set, and the first element set and the second element set may correspond to the component set.

The method may further include extracting at least some components to which the first element is applied from among at least one component included in the component set and providing print layout data obtained by arranging the at least some components in raw material data corresponding to the first element.

The method may further include calculating and providing a cost corresponding to the raw material data based on the print layout data.

An aspect provides an apparatus for generating design data. The apparatus includes memory and at least one processor connected to the memory. The memory includes instructions that, when executed by the at least one processor individually or collectively, cause the apparatus to obtain a first attribute information set corresponding to a first element set associated with a first style of a design item, obtain a second attribute information set corresponding to a second element set associated with each of at least one second style of the design item, in which each of the first element set and the second element set includes a first element and each of the first attribute information set and the second attribute information set includes first attribute information of the first element, and obtain a third style corresponding to the first style in response to user input to change the first attribute information to second attribute information in the first attribute information set.

### BRIEF DESCRIPTION OF DRAWINGS

FIG. 1A is a flowchart illustrating operations of a method of generating digital design data according to an embodiment.

FIG. 1B is a flowchart illustrating operations of a method of managing digital design data according to an embodiment.

FIG. 2 is a diagram illustrating a second generative attribute information set based on default attribute information according to an embodiment.

FIG. 3 is a diagram illustrating a generative style generated based on second generative attribute information according to an embodiment.

FIGS. 4A and 4B are diagrams illustrating a method of providing design data according to an embodiment.

FIG. 5 is a diagram illustrating a method of providing attribute information based on an attribute information list, according to an embodiment.

FIG. 6 is a diagram illustrating a method of generating a collection element according to an embodiment.

FIG. 7 is a diagram illustrating a method of generating a collection element according to an embodiment.

FIGS. 8A to 8C are diagrams illustrating a method of replacing an element with a collection element according to an embodiment.

FIG. 9 is a diagram illustrating an interface for replacing an element with a collection element according to an embodiment.

FIG. 10 is a diagram illustrating a device for performing a method of managing digital design data according to an embodiment.

### DETAILED DESCRIPTION

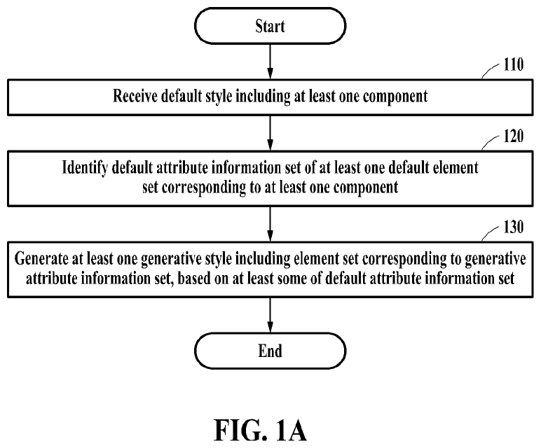

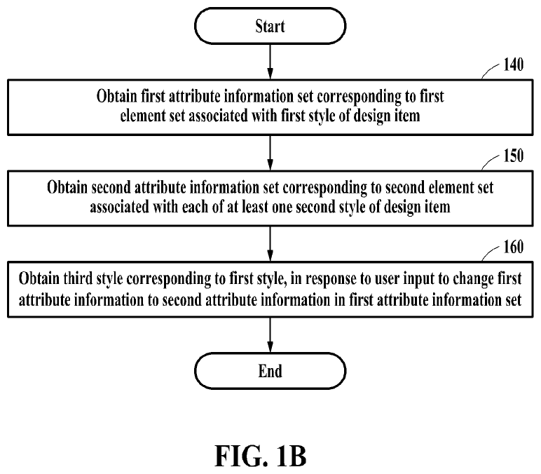

FIG. 1A is a flowchart illustrating operations of a method of generating digital design data according to an embodiment.

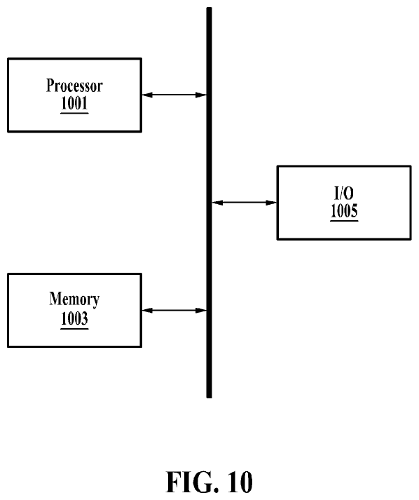

Referring to FIG. 1A, a process of generating design data by an electronic device (e.g., the electronic device 1000 of FIG. 10) through operations 110 to 130 for performing garment simulation according to an embodiment is illustrated.

Operations to be described hereinafter may be sequentially performed but not necessarily. For example, the order of the operations may be changed and at least two of the operations may be performed in parallel.

According to an embodiment, design data may include data that digitally represents visual elements, such as the shape, color, texture, and arrangement of a product or an object. The design data may represent a garment. For example, the design data may represent a shirt, pants, or a T-shirt.

According to an embodiment, design data may include a component set having at least one component. The components may correspond to detailed elements for forming a garment. For example, a design item may correspond to a shirt, and the component set for forming the shirt may include a collar pattern, a sleeve pattern, a body pattern, and body buttons.

A style may be applied to design data. To apply the style, an element may be applied to at least one component of a design item. A component set and an element set may correspond to each other.

An element may be defined in terms of attributes, such as color, material, texture, shape, or pattern, of an garment material. By combining elements, components with various forms of expression may be generated. For example, an element set corresponding to a component set may include cowhide applied to a collar pattern, cowhide applied to a sleeve pattern, silk applied to a body pattern, and mother-of-pearl buttons applied to body buttons.

In this disclosure, each element may be understood as an instance of a common attribute of garment materials used in garments. For example, elements may include, but are not limited to, fabric, graphic, trim, button, buttonhole, topstitch, puckering, and zipper.

“Fabric” may refer to a basic textile used to make garments. Fabric may be an element that determines the texture, durability, comfort, and appearance of a garment. Fabric may include various types, such as cotton, wool, silk, polyester, and other blended fabrics, each having unique properties and uses. The fabric used in a garment may vary depending on the intended use and style of the garment.

“Graphic” may refer to a visual image or design printed or embroidered on a garment. Graphics may be used to give garments a unique appearance, convey a message, or express a brand identity. Graphics may include, but are not limited to, logos, slogans, and/or pictures printed on a t-shirt.

“Trim” may refer to an element used to decorate or finish edges or specific parts of garments. Trims may include, but are not limited to, lace, ribbons, embroidery, beads, zippers, and/or buttons.

“Button” may refer to a small element used to open and close a garment. Buttons may be used as a design element on a garment to add style.

“Buttonhole” refers to a hole formed on a garment to allow a button to pass through and may serve as a design element for providing a closure function when paired with the button.

“Zipper” refers to a mechanical fastening element that enables opening and closing of a garment, including interlocking teeth attached to two tapes and a slider.

“Topstitch” refers to a stitch that is visible on the outer surface of a garment and may serve as a design element to provide a decorative effect or reinforce a seam. Examples may include decorative double stitching visibly formed along the edges of jeans pockets or accent stitching on the collar of a jacket but are not limited thereto.

“Puckering” refers to an irregular wrinkling or distortion that appears on the surface of fabric after sewing and may serve as a design element resulting from material imbalance or inconsistency in sewing tension. Examples may include irregular wrinkles in thin shirt fabric caused by thread tension at seam lines or fine puckers appearing around the waistband of a skirt but are not limited thereto.

An element according to an embodiment may be defined based on attribute information. A specific element may include attribute information within a predetermined range. For example, elements having first sub-attribute information, second sub-attribute information, or a combination of the first and second sub-attribute information within a predetermined range may be classified as the same element. Since elements are defined based on attribute information, an element set and an attribute information set may correspond to each other. For example, the attribute information set may include attribute information of cowhide applied to a collar pattern of a shirt, attribute information of cowhide applied to a sleeve pattern, attribute information of silk applied to a body pattern, and attribute information of mother-of-pearl buttons applied to body buttons.

Attribute information may include first sub-attribute information (e.g., intrinsic attribute) and second sub-attribute information (e.g., material). Here, the intrinsic attribute refers to physical property of an element and may include properties such as shape, weight, rigidity, and elasticity. The material refers to attribute information that defines visual property of an element and may include color and texture. For example, if an element corresponds to fabric, the attribute information of the element may include information related to intrinsic attributes (e.g., elasticity, thickness, or weight) of the fabric and materials (e.g., color and texture associated with cotton, wool, silk, polyester, and/or blended fabrics). Hereinafter, first sub-attribute information of an nth attribute information may be referred to as a n−1th attribute information, and second sub-attribute information of the nth attribute information may be referred to as a n−2th attribute information.

Colorway data may be generated based on a style including components to which elements having specific attribute information are applied. According to an embodiment, a colorway may refer to a set of garments to which a combination of various colors and/or materials (e.g., silk or wool) is applied based on a single garment design, that is, a set of garments having the same garment design but different colors and/or materials. A colorway may be used to simulate garments of the same design with various colors and/or materials. A user may determine an optimal combination of colors and/or materials through a colorway by visualizing and comparing various combinations or options of colors and/or materials.

Referring again to FIG. 1A, a method of managing digital design data according to an embodiment includes operation 110 of receiving a default style including at least one component. A default style according to an embodiment may correspond to a reference style for generating the design data (e.g., the colorway data) described above. Based on the default style, a user may generate one or more pieces of design data according to combinations of the various elements described above. The default style may be provided based on the user's selection input or, alternatively, may be automatically set as the default when only one style exists in the current browser window.

The method of managing digital design data according to an embodiment includes operation 120 of identifying default attribute information of at least one default element corresponding to at least one component. The electronic device may determine, for each of the at least one component included in the default style, default attribute information of a default element corresponding to the component. A default element may correspond to default attribute information. The default attribute information may include information related to intrinsic attributes and materials, as the first sub-attribute information and the second sub-attribute information, respectively, as described above.

The method of managing digital design data according to an embodiment includes operation 130 of generating at least one generative style including at least one generative element having generative attribute information, based on the default attribute information. The electronic device may generate a generative style as a new style based on the default style, using the default attribute information determined in operation 120. According to an embodiment, a generative style may include the same component as the default style. A generative element that is the same as or different from a default element may be applied to a component included in the generative style.

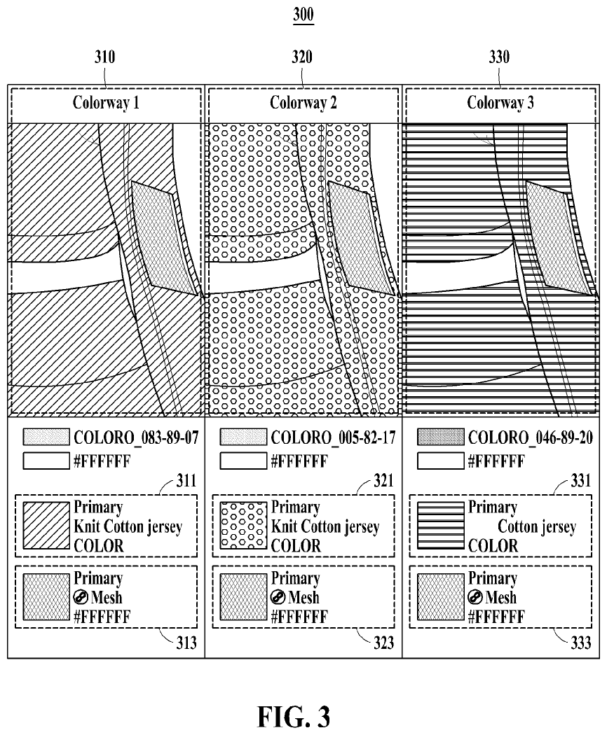

A generative element may include generative attribute information. The generative attribute information may include information related to intrinsic attributes and materials, as the first sub-attribute information and the second sub-attribute information, respectively, as described above. Since a generative element according to an embodiment is included in a separate style (i.e., a generative style) from a default element (included in the default style), the generative attribute information may be the same as or different from the default attribute information. A method of generating a generative style based on default attribute information will be described in more detail below with reference to FIG. 3.

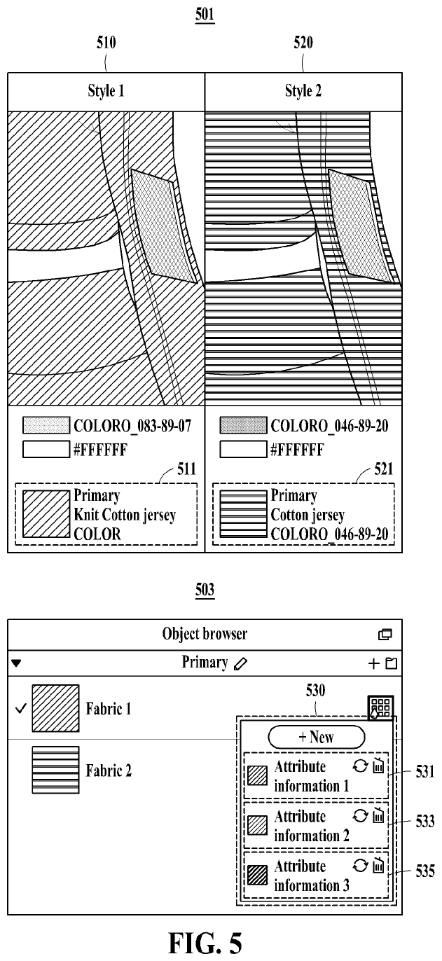

According to an embodiment, the electronic device may include loading an attribute information list corresponding to a default element and a generative element and generating at least one piece of attribute information included in the attribute information list. A method of providing attribute information based on an attribute information list will be described in more detail below with reference to FIG. 5.

FIG. 1B is a flowchart illustrating operations of a method of managing digital design data according to an embodiment.

The method of managing digital design data according to an embodiment includes operation 140 of obtaining a first attribute information set corresponding to a first element set associated with a first style of a design item. The first style may be associated with the first element set, which includes at least one element. The design item of the first style may include a component set to which the first element set is applied. At least one element included in the first element set may correspond to attribute information. The first attribute information set may include at least one piece of attribute information corresponding to at least one element. In this case, the first element set may include a first element, which may correspond to a piece of first attribute information.

The method of managing digital design data according to an embodiment includes operation 150 of obtaining a second attribute information set corresponding to a second element set associated with each of at least one second style of a design item. The second style may be associated with the second element set, which includes at least one element. The design item of the second style may include a component set to which the second element set is applied. At least one element included in the second element set may correspond to attribute information. The second attribute information set may include at least one piece of attribute information corresponding to at least one element. In this case, the second element set may include the first element included in the first element set. The second element set may include the first element, which may correspond to the first attribute information. The first style and the second style may each include a component to which the same first element is applied.

The method of managing digital design data according to an embodiment includes operation 160 of obtaining a third style corresponding to the first style, in response to user input to change first attribute information to second attribute information in the first attribute information set. The third style may correspond to the changed first style. An electronic device may receive user input (hereinafter, “user input for change”) for changing first attribute information of a first element, which corresponds to any one of the elements included in the first element set constituting the first style, to second attribute information.

The electronic device may receive the user input for change related to the first attribute information set associated with the first style. In other words, the first style may be a target style to be changed in response to the user input for change. The electronic device may obtain the third style associated with the changed first element set when the first element set of the first style is changed.

The electronic device may control the user input for change according to user settings. The user input for change may be controlled based on a user setting input associated with a previously generated style. Alternatively, the user input for change may be controlled based on a generative attribute information set during the generation of a new style through the method of generating design data described above with reference to FIG. 1A.

According to an embodiment, the user input for change may be controlled such that second attribute information is input while the first sub-attribute information of the first attribute information is fixed and only the second sub-attribute information is changed. For example, when a user desires to change the attribute information of red silk applied to a pocket of a shirt, the user input for change may be controlled such that only the color is changed to a different one, while maintaining the physical properties of the silk. In other words, the user input for change may be controlled such that attribute changes, such as from red silk to blue silk, are allowed, but changes involving physical properties, such as from red silk to red leather, are restricted. In this case, the first element included in the second element set of the second style may remain unchanged despite the user input for change.

According to an embodiment, the user input for change may be controlled such that the second attribute information is input by changing at least one of the first sub-attribute information and the second sub-attribute information of the first attribute information. For example, when the user desires to change the attribute information of red silk applied to a pocket of a shirt, the user input for change may be controlled such that both the color and the physical properties of the silk are changed. In other words, the user input for change may be controlled to allow changes even in physical properties, such as a change from red silk to blue leather. In this case, the first element included in the second element set of the second style may remain unchanged despite the user input for change.

According to an embodiment, operation 130 may further include obtaining at least one fourth style corresponding to at least one second style by applying the second attribute information to the first element of the second element set in response to the user input for change. In other words, if the first attribute information of the first element in the first style is changed, the first attribute information of the first element in the second element set of the second style may also be changed. The electronic device may obtain a fourth style associated with the changed second element set when the second element set of the second style is changed.

According to an embodiment, the electronic device may identify and extract at least some components, among a plurality of components included in a component set, to which the first element is applied. Subsequently, the electronic device may generate print layout data by arranging the extracted component on raw material data corresponding to the first element and provide the print layout data.

Print layout data refers to data including arrangement information, such as position, rotation, and size, for arranging components of design data on a raw material and may further include control parameters for processing, such as the width of the raw material, cutting reference lines, and allowances. Print layout data may be generated by the electronic device and then transmitted to a printing or cutting device to be used in an actual garment manufacturing process.

According to an embodiment, the electronic device may calculate a cost corresponding to raw material data based on print layout data and provide the calculated cost. The electronic device may calculate an area of raw material used by components arranged on the print layout data. The electronic device may calculate and provide an estimated cost based on the generated print layout data, reflecting a unit cost of raw material and garment material conditions corresponding to the first element.

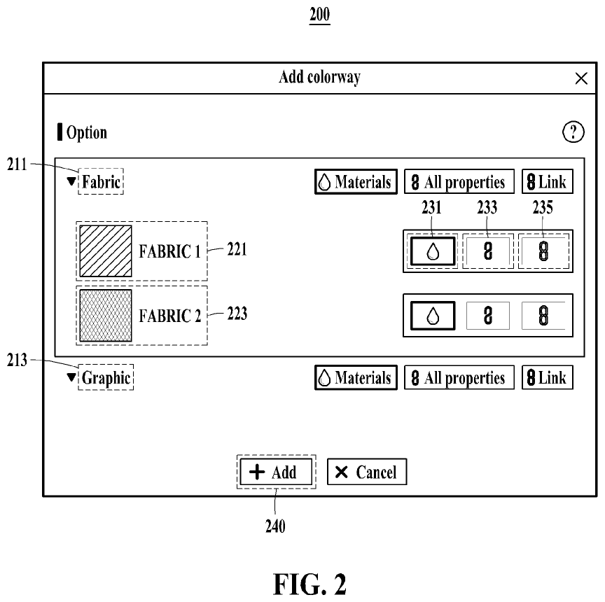

FIG. 2 is a diagram illustrating a second generative attribute information set based on default attribute information according to an embodiment.

Referring to FIG. 2, an interface 200 for generating a generative style is illustrated. The interface 200 may display element items (e.g., a fabric item 211 and a graphic item 213) and default elements (e.g., default element 1 221 and default element 2 223). The interface 200 may display all default elements included in a default style. Default elements may be displayed per element item. For example, default element 1 221 and default element 2 223 included in the default style may be displayed in response to the fabric item 211 among the element items.

The interface 200 may include UI(user interface) elements 231, 233, and 235 for setting generative attribute information of generative elements to be included in the generative style to be added, for each of the default elements 221 and 223. The interface 200 may include an UI element 240 for generating a generative style upon completion of the selection of generative attribute information.

According to an embodiment, generative attribute information may include first generative attribute information that includes first sub-attribute information of the default attribute information, and second sub-attribute information that is different from the second sub-attribute information of the default attribute information. The first generative attribute information may have the same first sub-attribute information as the default attribute information but may differ in only the second sub-attribute information (e.g., material such as color or texture). For example, if an element corresponds to fabric and the default element corresponds to white cotton fabric, a generative element having the first generative attribute information may correspond to fabric of the same cotton material, but with the color configured to be the same (e.g., white) or different (e.g., blue). In other words, the first generative attribute information may be used to generate a generative element in which only a visual representation (e.g., color) is changed while the first sub-attribute information of the default element is maintained. According to an embodiment, the first generative attribute information may be controlled such that changes to the first sub-attribute information are restricted and only the second sub-attribute information may be changed.

According to an embodiment, the first sub-attribute information of the first generative attribute information may depend on the first sub-attribute information of the default attribute information. More specifically, the first sub-attribute information of the generative attribute information may be based on the first sub-attribute information of the default attribute information. Therefore, when the first sub-attribute information of the default attribute information is changed, the first sub-attribute information of the generative attribute information may also be changed. For example, if the default element is changed from cotton fabric to silk fabric, the generative element may also be changed from cotton fabric to silk fabric. In this case, the second sub-attribute information of the generative attribute information may remain unchanged. For example, if the default element is changed from red cotton fabric to blue silk fabric, the generative element may be changed from yellow cotton fabric to yellow silk fabric. In an embodiment, when the first sub-attribute information of the default attribute information is maintained and only the second sub-attribute information is changed, the generative attribute information may remain the same as before the change to the default attribute information.

According to an embodiment, through a selection input corresponding to UI element 1 231 on the interface 200, the generative style to be added may be configured to include a generative element having first sub-attribute information. Through this, the generative style may be generated to include a generative element that has the same first and second sub-attribute information as the default element 221.

According to an embodiment, generative attribute information may include second generative attribute information that includes first sub-attribute information, and second sub-attribute information, which may be configured independently of the default attribute information. The second generative attribute information may be configured to include the first sub-attribute information and the second sub-attribute information independently of the default attribute information. For example, the second generative attribute information may be configured to include first sub-attribute information that is different from the first sub-attribute information of the default attribute information and second sub-attribute information that is different from the second sub-attribute information of the default attribute information. For example, if the element corresponds to fabric, the generative element may be fabric made of a different material from the default element. In addition, if the element corresponds to a button, the generative element may have a shape different from that of the button in the default element. The second generative attribute information may maintain the first sub-attribute information and the second sub-attribute information regardless of any change in the default attribute information.

According to an embodiment, through a selection input corresponding to UI element 2 233 on the interface 200, the generative style to be added may be configured to include a generative element having second generative attribute information. Through this, the generative style may be generated to include a generative element having generative attribute information that is independent of the default element 221.

According to an embodiment, generative attribute information may include third generative attribute information, which includes the default attribute information. The third generative attribute information according to an embodiment may correspond to the same attribute information as the default attribute information. The third generative attribute information according to an embodiment may depend on the default attribute information. More specifically, when a first change is made to the default attribute information, the same first change may be applied to the third generative attribute information. In addition, when a second change is made to the default attribute information, the same second change may be applied to the third generative attribute information.

According to an embodiment, through a selection input corresponding to UI element 3 235 on the interface 200, the generative style to be added may be configured to include a generative element having third generative attribute information. Through this, the generative style may be generated to include a generative element having the same generative attribute information as the default element 221.

FIG. 3 is a diagram illustrating a generative style generated based on second generative attribute information according to an embodiment.

Referring to FIG. 3, an interface 300 for displaying styles is illustrated. The interface 300 may include a default style 310, generative style 1 320, and generative style 2 330. Generative style 1 320 and generative style 2 330 may correspond to styles generated based on the default style 310. The styles displayed on the interface 300 may be displayed together with elements included in each style.

According to an embodiment, the default style 310 may include default element 1 311 and default element 2 313. Generative style 1 320 and generative style 2 330 may correspond to styles generated to include generative elements having a generative attribute information set based on the default attribute information of each of default element 1 311 and default element 2 313.

According to an embodiment, generative style 1 320 may include generative element 1-1 321 configured to have first generative attribute information based on the default attribute information of default element 1 311. In addition, generative style 1 320 may include generative element 1-2 323 configured to have third generative attribute information based on the default attribute information of default element 2 313.

According to an embodiment, generative style 2 330 may include generative element 2-1 331 configured to have second generative attribute information based on the default attribute information of default element 1 311. In addition, generative style 2 330 may include generative element 2-2 333 configured to have third generative attribute information based on the default attribute information of default element 2 313.

According to an embodiment, generative element 1-1 321 may correspond to a generative element in which first generative attribute information is set, and has first sub-attribute information that is the same as the first sub-attribute information of default element 1 311 (e.g., knit cotton), but second sub-attribute information (e.g., dotted pattern) that is different from the second sub-attribute information of default element 1 311 (e.g., cross-hatched pattern).

A user input to change generative element 1-1 321 may be controlled to allow only the second sub-attribute information of generative element 1-1 321 to be changed. For example, the user input for change may be controlled such that changing the first sub-attribute information of generative element 1-1 321 from knitted cotton jersey to silk is not allowed, while changing the second sub-attribute information from polka dots to stripes is allowed.

According to an embodiment, the first sub-attribute information of generative element 1-1 321 may also be changed when the first sub-attribute information of default element 1 311 is changed. For example, if the first sub-attribute information of default element 1 311 is changed from knitted cotton jersey to silk, the first sub-attribute information of generative element 1-1 321 may also be changed from knitted cotton jersey to silk. In this case, the second sub-attribute information (e.g., polka dot pattern) of generative element 1-1 321 may remain unchanged.

According to an embodiment, generative element 2-1 331 may correspond to a generative element in which second generative attribute information is set, and which has first sub-attribute information (e.g., cotton jersey) different from the first sub-attribute information (e.g., knitted cotton jersey) of default element 1 311, and second sub-attribute information (e.g., striped pattern) different from the second sub-attribute information (e.g., diagonal pattern) of default element 1 311. The second generative attribute information of generative element 2-1 331 may be maintained independently of any change in the first sub-attribute information of default element 1 311.

According to an embodiment, generative element 1-2 323 or generative element 2-2 333 may correspond to elements that include the same first sub-attribute information (e.g., mesh) and second sub-attribute information (e.g., wave pattern) as those of default element 2 313. When any one of default element 2 313, second element 1 323, or second element 2 333 is changed, the change may be applied to the others in the same manner.

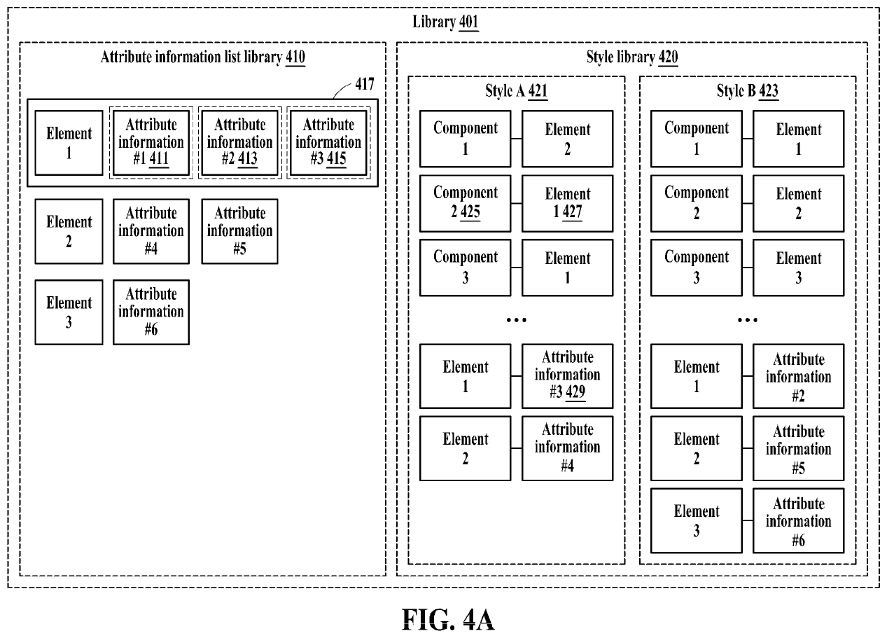

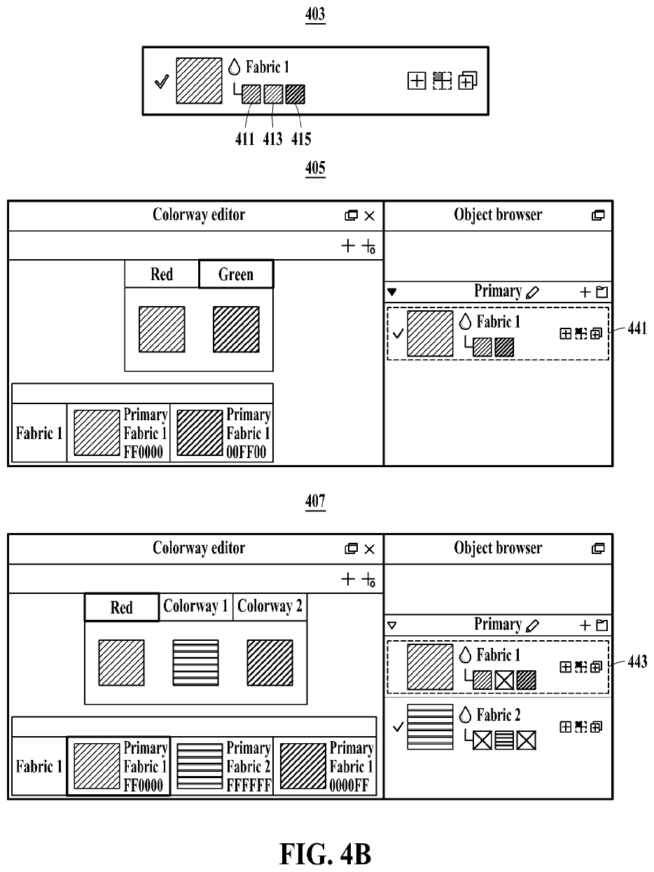

FIGS. 4A and 4B are diagrams illustrating a method of providing design data according to an embodiment.

Referring to FIG. 4A, a library 401 for managing elements applied to a style and an attribute information list corresponding to each of the elements is illustrated. The library 401 may include an attribute information list library 410 and a style library 420.

Design data used in garment simulation may include a list of associated attribute information for elements included in a style. The attribute information list may include, for each element, attribute information on associated elements. The associated elements may share some attribute information with the corresponding element, while differing in the remaining attribute information. For example, the associated elements may have the same intrinsic attributes as the corresponding elements but differ in material.

As a more specific example, referring to the attribute information list 410, assume that element 1 is defined as cotton fabric. The associated elements may correspond to a plurality of elements that share the intrinsic properties of cotton but differ only in visual characteristics, such as diagonal-patterned cotton, polka-dot cotton, or striped cotton. In this case, the attribute information list may include attribute information corresponding to each associated element, such as attribute information 1 411 of diagonal-patterned cotton, attribute information 2 413 of polka-dot cotton, and attribute information 3 415 of striped cotton. Such a list of attribute information may be included and stored together as a list of attribute information within the data of each element (e.g., hatched cotton, polka-dot cotton, or striped cotton).

The attribute information list library 410 may include attribute information lists for respective elements applied to styles in the style library 420. For example, the attribute information list library 410 may include attribute information list 417 for element 1 applied to style A 421.

The style library 420 may include data for styles generated in the current project file. For example, when styles generated in the current project include style A 421 and style B 423, the style library 420 may include corresponding data for each of style A 421 and style B 423.

The style library 420 may include data related to a component set for each included style and data related to an element set corresponding to the component set. In addition, the style library 420 may include data related to attribute information currently applied to each element included in the element set. For example, the style library 420 may include data of style A 421 and data related to component 2 425 (e.g., a pattern) included in style A 421. In addition, the style library 420 may include data related to element 1 427 applied to component 2 425. In addition, the style library 420 may include data related to attribute information 3 429 corresponding to element 1 427.

Referring to FIG. 4B, screens 405 and 407 are illustrated, which allow editing of attribute information based only on elements of previously generated styles. According to an embodiment, during generation of design data, an element may be generated within a structure (hereinafter, the “linked structure”) associated with a single style. For example, whenever a style is added, a new element with corresponding attribute information may be generated, and conversely, when the style is deleted, the associated element may be deleted. In this linked structure, since the number of attribute information items for an element is determined by the number of styles, each style may include the same number of attribute information items for the element.

For example, two styles, ‘Style A’ and ‘Style B’, may exist for a single piece of design data (e.g., a one-piece dress). It may be assumed that the design data includes a first component (e.g., a top pattern) and a second component (e.g., a bottom pattern), and that two fabrics corresponding to the respective components are used.

In the linked structure, since all styles are configured to have the same number of attribute information items for elements, a user is required to set elements corresponding to the first component (e.g., a top pattern) and the second component (e.g., a bottom pattern) for each style. However, even when both Style A and Style B are intended to use the same top element (e.g., red cotton) and differ only in the bottom element, a separate top element (e.g., red cotton) is still required to be generated for Style B. As a result, unnecessary elements may be additionally generated, even though the same element is actually used.

In the above-described linked structure, if only a portion of the attribute information list registered with a specific element is applied to a style, the remaining attribute information may not be accessible. For example, screens 405 and 407 may reflect only attribute information 1 411 and attribute information 3 415 among various pieces of attribute information 411, 413, and 415 included in an attribute information list interface 403.

Screen 405 shows a mismatch between the number of attribute information items (e.g., 3) in the attribute information list interface 403 and the number of styles (e.g., 2). Element interface 1 441 of screen 407 may be an interface for displaying element 1 (e.g., Fabric 1) corresponding to the attribute information list. Since two styles are currently generated, only two attribute information items (attribute information 1 411 and attribute information 3 415) corresponding to the element applied on element interface 1 441 may be displayed. In screen 405, the use of attribute information 2 413 in editing styles may be difficult unless a separate style using it is generated.

In addition, screen 407 shows a match between the number of attribute information items (e.g., 3) included in the attribute information list interface 403 and the number of styles (e.g., 3), but only some materials are reflected in the styles. Element interface 2 443 of screen 407 may be an interface for displaying element 1 corresponding to the attribute information list. Since two out of three styles are currently generated, only two attribute information items (attribute information 1 411 and attribute information 3 415) may be displayed on element interface 2 443, and the remaining attribute information item may be set to a NULL value. In screen 407, the use of attribute information 2 413 may also be limited, as in screen 405.

FIG. 5 is a diagram illustrating a method of providing attribute information based on an attribute information list, according to an embodiment.

In an embodiment, an electronic device may be configured to load an attribute information list and provide at least one piece of attribute information included in the attribute information list. According to an embodiment, the electronic device may load an attribute information list corresponding to each element to which a style is applied. The electronic device may provide attribute information included in the loaded attribute information list.

Referring to FIG. 5, an interface 501 for displaying currently generated styles and a list interface 503 of elements applied to the currently generated styles are illustrated. The interface 501 may include currently generated styles, such as style 1 510 and style 2 520. The list interface 503 may include element 1 511 of style 1 510 and element 2 521 of style 2 520. The list interface 503 may further include an attribute information list interface 530 for displaying the attribute information list of element 1 511 of style 1 510.

Here, element 1 511 and element 2 521 are separate elements and may not be associated with each other. In this case, according to the linked structure described above with reference to FIG. 4, since no element is associated with element 1 511 in the currently generated styles, only one piece of attribute information (attribute information 1 531 of element 1 511) may be displayed. Unlike the linked structure, the list interface 503 may display the attribute information list interface 530 that includes editable attribute information based on the attribute information list of element 1 511, regardless of the presence of the corresponding style. For example, the list interface 503 may display, in addition to attribute information 1 531 of element 1 511, attribute information 2 533 and attribute information 3 535 registered in element 1 511. The attribute information list interface 530 may further include an UI element for deleting attribute information included in the attribute information list or updating the attribute information to the latest attribute information.

This may enable the electronic device to implement a function for rapidly searching associated attribute information and suggesting alternative attribute information when a specific element is selected. In addition, unlike in the linked structure, the electronic device may generate, apply, and delete attribute information regardless of the number of styles, thereby preventing the automatic generation and retention of unnecessary attribute information. Accordingly, waste of file capacity may be reduced, and management efficiency may be improved while maintaining the consistency and quality of raw material data.

In addition, the electronic device eliminates the conventional inefficient procedure of manually editing styles one by one to check or delete unused attribute information and enables direct checking and editing at the attribute information level, thereby achieving a reduction in work time and repetitive operations.

According to an embodiment, an attribute information list registered in an element may be provided in connection with a server. According to an embodiment, a server may enable a vendor-side terminal for garment production and a designer-side terminal for providing raw materials to communicate with each other and exchange data. For example, a designer may register an attribute information list on a server, and a vendor may produce garments based on the attribute information list registered on the server. By providing an attribute information list linked to the server, communication costs between designers and vendors may be reduced, and raw materials may be freely edited and updated without being restricted by the work sequence because real-time changes may be shared. This may enable greater flexibility in the workflow and enhance the creativity of designers.

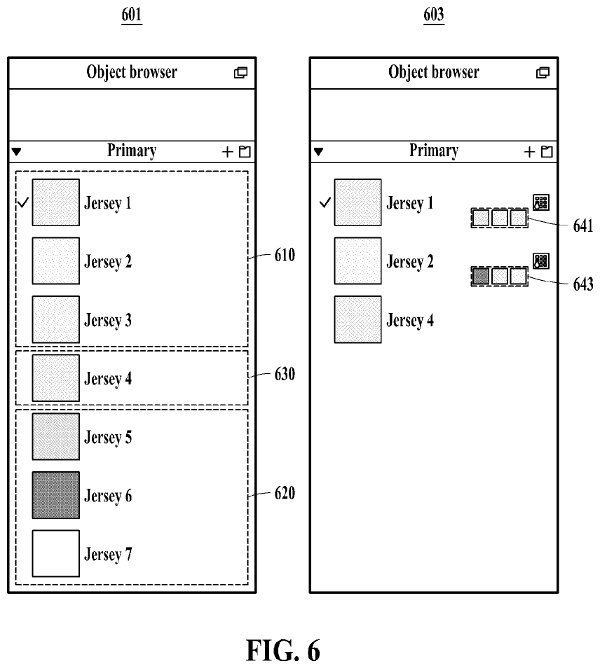

FIG. 6 is a diagram illustrating a method of generating a collection element according to an embodiment.

According to an embodiment, a method of managing digital design data may include generating at least one collection element based on a plurality of elements included in at least one first element set and in at least one second element set associated with at least one second style. According to an embodiment, a collection element may include at least one piece of first sub-attribute information and a plurality of second sub-attribute information.

According to an embodiment, a collection element may correspond to a set derived from a plurality of elements and may be classified into one of the following two types based on its structure.

First, a collection element may correspond to a collection of elements (hereinafter, an “element collection”). In this case, the collection element may be configured as a set of a plurality of different elements, and each of the elements may have first sub-attribute information and second sub-attribute information. In other words, a collection element in the form of an element collection may include a complex combination of pieces of first sub-attribute information and pieces of second sub-attribute information. Accordingly, the relationship between the first sub-attribute information and the second sub-attribute information may be defined as a many-to-many relationship.

Second, a collection element may correspond to a set of second sub-attribute information associated with a single piece of first sub-attribute information. The collection element may correspond to a form in which various selection options for second sub-attribute information are provided by including a plurality of second sub-attribute information as a single element. For example, the collection element may correspond to a form in which first sub-attribute information is shared and different pieces of second sub-attribute information are included. The collection element having the form of a set of second sub-attribute information may have a structure in which pieces of second sub-attribute information are linked to a single element, representing a one-to-many relationship.

In this case, the plurality of pieces of second sub-attribute information included in the collection element may be managed separately from the second sub-attribute information of the element on which the collection element is based.

Depending on the intended use or configuration method, the relationship structure (e.g., a many-to-many relationship or a one-to-many relationship) between first sub-attribute information and second sub-attribute information of a collection element may vary. Each structure may be used for user selection-based colorway configuration or automatic style recommendation.

According to an embodiment, an electronic device may group a plurality of elements into at least one element group based on a predefined condition and generate a collection element corresponding to each of the at least one element group. In this case, the element group may be generated in response to receiving a user selection input or be generated automatically.

According to an embodiment, a predefined condition may serve as a criterion for grouping elements. A collection element may be generated based on a group formed under a predefined condition. According to an embodiment, a predefined condition may include a condition based on common first sub-attribute information. In this case, each of the generated collection elements may include common first sub-attribute information and pieces of second sub-attribute information of the elements belonging to the corresponding element group.

According to an embodiment, an element to be grouped into an element group may include an element that has common first sub-attribute information among generative elements generated to have the second generative attribute information described above, or an element included in arbitrarily added style and sharing common first sub-attribute information with existing elements.

For example, a generative element generated to have the second generative attribute information described above may include an element that is reconfigured to have the second generative attribute information, such that the corresponding default element has independent attribute information when a generative element having the first or third generative attribute information is generated. In this case, the generative element reconfigured to have the second generative attribute information may belong to the same element group as the default element to which it previously corresponded.

For another example, the arbitrarily added element described above may correspond to an element generated separately by the user, instead of being added during generative style generation. In this case, the arbitrarily added element may include attribute information independent of existing elements.

Referring to FIG. 6, list interface 1 601 is illustrated, which displays elements included in a currently generated style. Among the elements displayed in interface 1 601, it may be assumed that the elements belonging to element group 1 610 have first sub-attribute information 1, the elements belonging to element group 2 620 have first sub-attribute information 2, and element 630 has first sub-attribute information 3.

The electronic device may generate element group 1 610 based on first sub-attribute information 1 and element group 2 620 based on first sub-attribute information 2, respectively. The electronic device may generate collection element 1 641 and collection element 2 643 corresponding to element group 1 610 and element group 2 620, respectively. Collection element 1 641 may include attribute information of elements belonging to element group 1 610. In addition, collection element 2 643 may include attribute information of elements in element group 2 620.

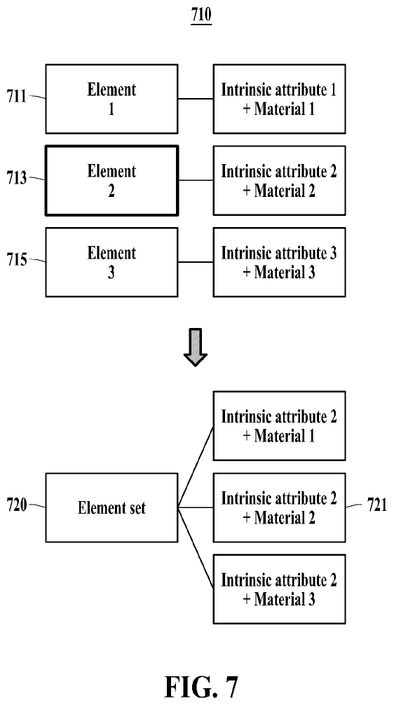

FIG. 7 is a diagram illustrating a method of generating a collection element according to an embodiment.

According to an embodiment, an electronic device may receive a selection input corresponding to at least some of a plurality of elements included in at least one first element set and at least one second element set. The electronic device may generate a collection element in response to user input to select one element from at least some of a plurality of elements corresponding to a selection input, the collection element including first sub-attribute information of the selected element and pieces of second sub-attribute information of at least some of the plurality of elements.

In addition to automatically generating collection elements based on elements having common first sub-attribute information, the electronic device may also generate collection elements in response to a user's selection input. As the user arbitrarily selects elements, the selected elements may include different pieces of attribute information. For example, there may be cases in which the selected elements do not include the same first sub-attribute information.

In this case, the electronic device may either automatically designate one of the selected elements or receive a selection input corresponding to one of the elements. The electronic device may generate a collection element that includes the first sub-attribute information of one selected element and the second sub-attribute information of at least some of the remaining selected elements.

For example, the electronic device may receive user input for selecting one element corresponding to at least some of a plurality of selected elements. In this case, the electronic device may generate a collection element including the first sub-attribute information of one selected element and the second sub-attribute information of the selected elements. In this case, the attribute information included in the collection element may be managed separately from the attribute information of the selected elements.

Referring to FIG. 7, the electronic device may receive a selection input corresponding to a plurality of elements 710. The plurality of elements 710 in an example may include different pieces of attribute information. For example, element 1 711 may include intrinsic attribute 1 and material 1, element 2 713 may include intrinsic attribute 2 and material 2, and element 3 715 may include intrinsic attribute 3 and material 3. The electronic device may automatically select element 2 713 or may receive a selection input corresponding to element 2 713. The electronic device may generate collection element 720 based on the intrinsic attribute 2 of element 2 713. The generated collection element 720 may be generated to include intrinsic attribute 2 and a plurality of materials (material 1, material 2, and material 3) included in the plurality of elements 710. In this case, the attribute information of element 2 713 and the attribute information 721 may be managed as separate pieces of attribute information.

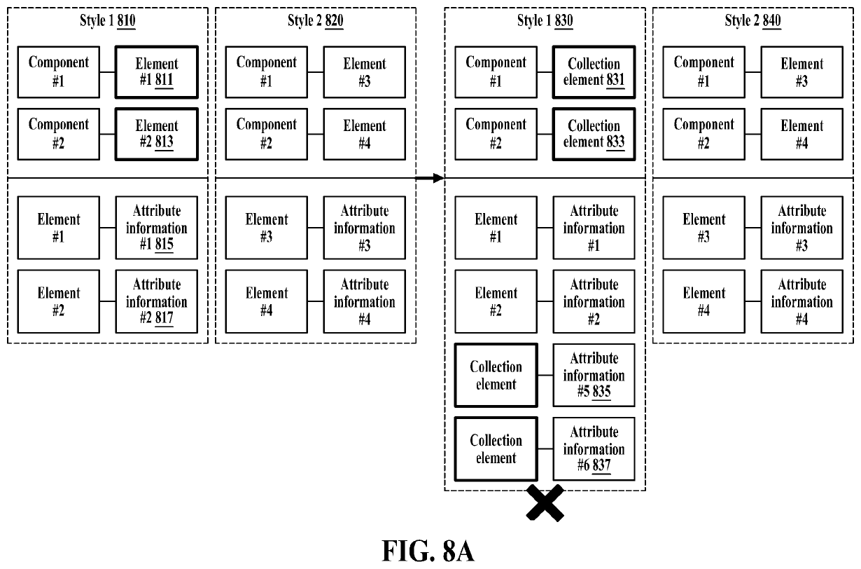

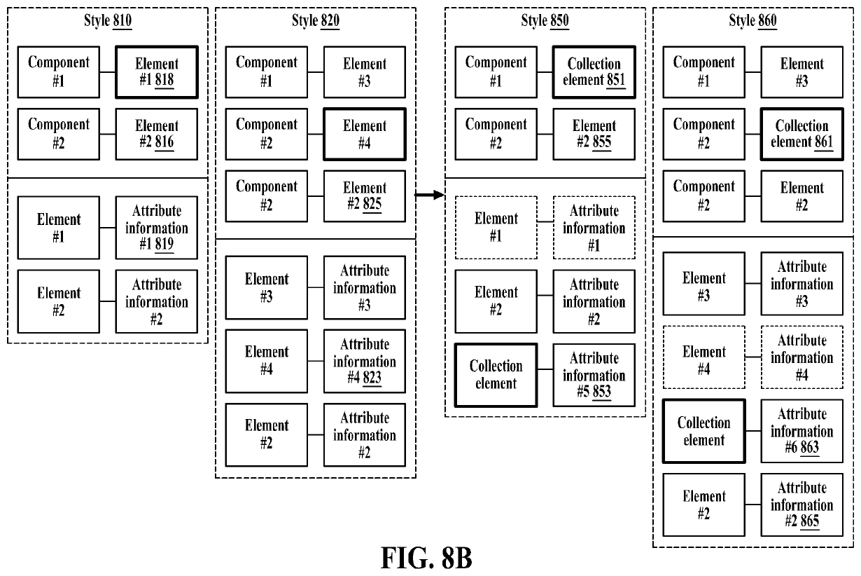

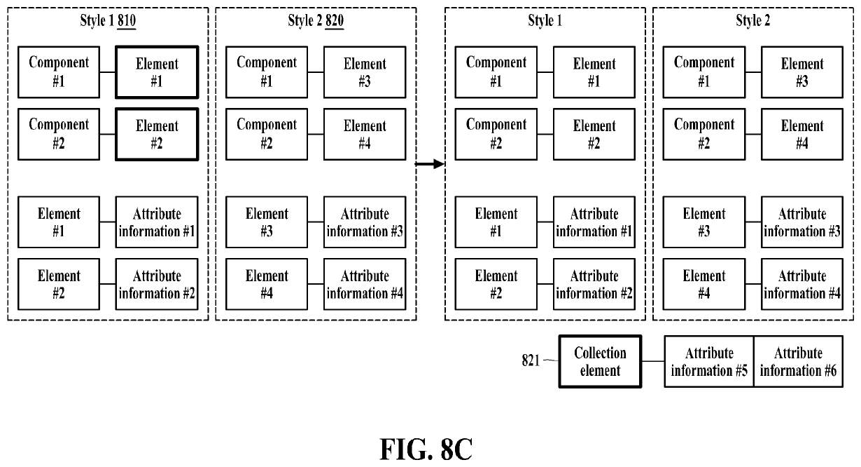

FIGS. 8A to 8C are diagrams illustrating a method of replacing an element with a collection element according to an embodiment.

To identify the types of raw materials actually used in garment production, attribute information of each of at least one element included in a style may be controlled not to overlap with that of another in a design data generation system. In other words, in the design data generation system, each element within a style may be controlled to have a unique piece of attribute information, such that the used raw materials may be accurately identified without duplication.

A collection element may be applied by replacing existing elements within a style at the time of generation. In other words, a collection element may be applied as a single element, and a collection element including attribute information reflecting that of an existing element may be used.

More specifically, an electronic device may identify second sub-attribute information of a corresponding element and replace the element with the corresponding collection element to which the identified second sub-attribute information is applied.

For example, FIG. 8A illustrates a collection element as generated based on element 1 811 and element 2 813 within style 1 810. Element 1 811 may be replaced with collection element 831 including attribute information 5 835 corresponding to attribute information 1 815. In addition, element 2 813 may be replaced with collection element 833 including attribute information 6 837 corresponding to attribute information 2 817.

However, when a collection element corresponding to two or more elements is generated in a single style and applied to at least one of the elements corresponding to the collection element, the collection element may include two or more pieces of attribute information within the same style. In other words, a collection element used as a single element within a style may include two or more pieces of attribute information. For example, referring again to FIG. 8A, collection element 831 and collection element 833 may be applied to a single style as the same element but may correspond to attribute information 5 835 and attribute information 6 837, respectively. In the real world, raw materials used in garments necessarily have a single intrinsic attribute. If a plurality of different attributes are assigned to one raw material, this may be inconsistent with its applicability in actual manufacturing and management processes and may not align with practical use cases or industrial requirements.

Accordingly, if a collection element is generated based on a plurality of elements included in a plurality of styles, the electronic device may replace each of the plurality of elements with the corresponding collection element. The electronic device may not perform the replacement if the collection element is based on a plurality of elements from a single style.

For example, FIG. 8B illustrates a process in which a generated collection element is applied based on the selection of elements included in a plurality of styles. The electronic device may generate a collection element corresponding to element 1 818 and element 4 821, which are included in a plurality of styles, from among a plurality of elements (e.g., element 1 818 and element 2 of style 1 810, and element 3, element 4, and element 2 of style 2 820).

In this case, the electronic device may identify attribute information 1 819 of element 1 818 included in style 1 810 and replace element 1 818 with collection element 851, including attribute information 5 853 corresponding to attribute information 1 819. In addition, the electronic device may identify attribute information 4 823 of element 4 821 included in style 2 820 and replace element 4 821 with collection element 861 including attribute information 6 863 corresponding to attribute information 4 823.

In this case, even if element 1 818 in replaced style 1 850 is set to collection element 851 including attribute information 5 853, no duplicate attribute information may be generated in the style. Similarly, in replaced style 2 860, even if element 4 821 is set to collection element 861 including attribute information 5 853, duplicate attribute information may not be generated within the style.

In this case, even when an element included in a plurality of styles is selected, replacement with a collection element may not be performed if a collection element is generated based on a plurality of elements included in a single style.

For example, referring to FIG. 8B, generating a collection element based on element 1 818 of style 1 810 and element 2 825 of style 2 820 corresponds to a collection element as generated based on a plurality of elements in a single style. In other words, this corresponds to the same case as when a collection element is generated based on element 1 818 and element 2 included in style 1 810. More specifically, when element 2 855 of changed style 1 850 is replaced with a collection element of attribute information 7 (not shown for ease of description) corresponding to attribute information 2 816, a single collection element in changed style 1 850 may include two pieces of attribute information (attribute information 5 853 and attribute information 7). As described above with reference to FIG. 8A, when a single element may have overlapping attribute information, the replacement operation may not be performed.

According to an embodiment, if a selection input corresponds to a plurality of elements in a single style, replacement with a collection element may not be allowed, although generation of the collection element may still be performed. For example, FIG. 8C illustrates two or more elements as selected in style 1 810, as in FIG. 8A. Even in this case, a collection element may be generated and stored in a library corresponding to the first style and the second style as data separate from the currently applied element. According to an embodiment, the library corresponding to the first style and the second style may include the library 401, the attribute information list library 410, and the style library 420, as described above with reference to FIG. 4A.

According to an embodiment, when a single object generated based on a plurality of elements is no longer applicable due to subsequent deletion of an element, the electronic device may replace the element with a collection element.

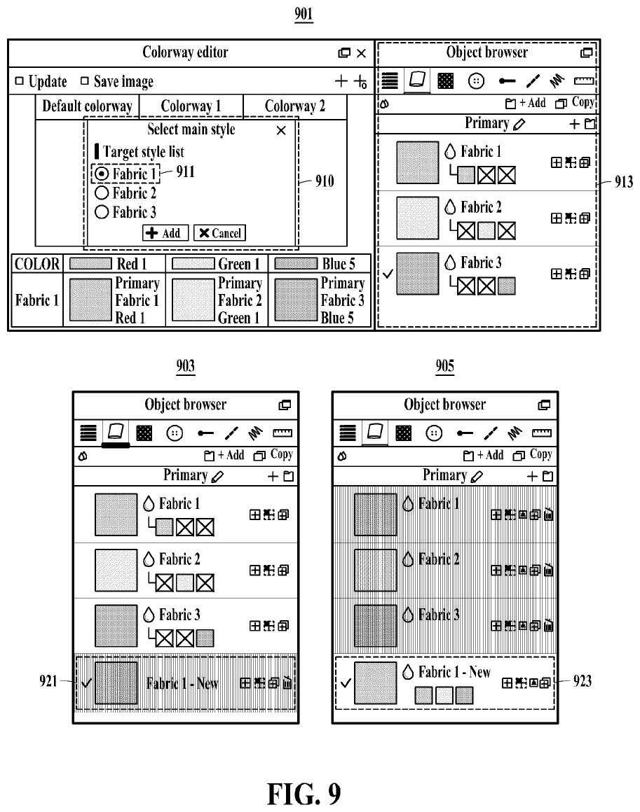

FIG. 9 is a diagram illustrating an interface for replacing an element with a collection element according to an embodiment.

Screen 901 shows a process of generating a collection element. Screen 901 may include an interface 910 for selecting an element whose attribute information is to be shared across collection elements, in response to selection inputs for element 1, element 2, and element 3. Element list interface 1 913 may display element 1, element 2, and element 3. Screen 901 shows element 1 button 911 as selected on the interface 910.

In response to the selection of element 1 button 911, collection elements 921 and 923 may be generated. Element list interface 2 903 shows the collection element 921 as generated while element 1, element 2, and element 3 are maintained. Element list interface 3 905 shows the collection element 923 as generated, and each of element 1, element 2, and element 3 is replaced with collection element 923.

FIG. 10 is a diagram illustrating a device for performing a method of managing digital design data according to an embodiment.

Referring to FIG. 10, according to an embodiment, an electronic device 1000 may include a processor 1001 and memory 1003. In addition, an input/output (I/O) device 1005 may be further included depending on the implementation. The electronic device 1000 may include a device that performs the method of managing digital design data described above with reference to FIGS. 1 through 9. Hereinafter, the electronic device 1000 is simply referred to as the “device”.

The processor 1001 according to an embodiment may perform at least one operation of the method of managing digital design data as described above with reference to FIGS. 1 through 9. For example, the processor 1001 may perform at least one of: receiving a first style including at least one component; identifying first attribute information of at least one first element corresponding to the component; and generating at least one second style including at least one second element having second attribute information based on the first attribute information.

The memory 1003 according to an embodiment may be volatile memory or non-volatile memory, and may store data related to the method of managing digital design data as described above with reference to FIGS. 1 through 9. For example, the memory 1003 may store data generated during the execution of the method of managing digital design data, or data required to perform the method of managing digital design data. For example, the memory 1003 may store at least one of a style, a component, an element, and a collection element.

The electronic device 1000 according to an embodiment may exchange data, via the I/O device 1005, with a user or an external device (e.g., a personal computer or a network). For example, the device 1000 may receive, via the I/O device 1005, style data as a target for generating design data and may output style data generated based on the input style data.

According to an embodiment, the memory 1003 may store a program that implements the method of managing digital design data as described above with reference to FIGS. 1 through 9. The processor 1001 may execute the program stored in the memory 1003 and control the device 1000. Program code to be executed by the processor 1001 may be stored in the memory 1003.

The electronic device 1000 according to an embodiment may further include other components not shown in the drawings. For example, the device 1000 may include a communication module that provides a function for the device 1000 to communicate with another electronic device or another server via a network. Part or all of the program for generating design data may be stored in external memory. The device 1000 may communicate, via the communication module, with the program for generating design data stored in the external memory to obtain at least one of a style, component, element, and collection element. In another example, the device 1000 may further include other components, such as a transceiver, various sensors, and a database.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random-access memory (RAM), flash memory, and the like. Examples of program instructions include both machine code, such as produced by a compiler, and files containing higher-level code that may be executed by the computer using an interpreter. The above-described devices may be configured to act as one or more software modules in order to perform the operations of the above-described embodiments, or vice versa.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

A number of embodiments have been described above. Nevertheless, it should be understood that various modifications may be made to these embodiments. Suitable results may be achieved if the described techniques are performed in a different order, and/or if components in a described system, architecture, device, or circuit are combined in a different manner, and/or replaced or supplemented by other components or their equivalents.

Therefore, other implementations, other examples, and equivalents to the claims are also within the scope of the following claims.

1. A method of managing a digital design item, the method comprising:
obtaining, corresponding to a first style of a design item, a first attribute information set corresponding to a first element set associated with a component set included in the design item;
obtaining, corresponding to a second style of the design item, a second attribute information set corresponding to a second element set associated with the component set, wherein each of the first element set and the second element set includes a first element in common, and each of the first attribute information set and the second attribute information set includes first attribute information corresponding to the first element; and
in response to user input to change the first attribute information to second attribute information in the first attribute information set, obtaining a third style corresponding to the first style by applying the second attribute information to the first element of the first element set.

2. The method of claim 1, wherein the first attribute information and the second attribute information comprise:
first sub-attribute information corresponding to a physical attribute and second sub-attribute information corresponding to a visual attribute.

3. The method of claim 1, wherein the user input to change the first attribute information to the second attribute information is controlled such that second attribute information in which only second sub-attribute information of the first attribute information is changed is input.

4. The method of claim 1, wherein the user input to change the first attribute information to the second attribute information is controlled such that second attribute information in which at least one of first sub-attribute information and second sub-attribute information of the first attribute information is changed is input.

5. The method of claim 1, wherein the obtaining of the third style comprises:
in response to the user input, obtaining at least one fourth style corresponding to the at least one second style by applying the second attribute information to the first element of the second element set.

6. The method of claim 1, further comprising:
generating at least one collection element corresponding to at least some of a plurality of elements included in the first element set and in at least one second element set associated with the at least one second style,
wherein each of the at least one collection element corresponds to at least one piece of first sub-attribute information and pieces of second sub-attribute information.

7. The method of claim 6, wherein the generating of the at least one collection element comprises:
grouping the plurality of elements into at least one element group, based on a condition related to common first sub-attribute information; and
generating, for each of the at least one element group, a collection element corresponding to the common first sub-attribute information and to pieces of second sub-attribute information associated with the corresponding element group.

8. The method of claim 6, further comprising:
receiving a selection input corresponding to at least some of the plurality of elements, and the generating of the at least one collection element comprises:
in response to user input to select any one element from the at least some of the plurality of elements, generating a collection element corresponding to first sub-attribute information of the selected element and to pieces of second sub-attribute information corresponding to at least some of the plurality of elements.

9. The method of claim 6, further comprising:
replacing each of at least some of the plurality of elements with a corresponding collection element.

10. The method of claim 9, wherein the replacing comprises:
for each of at least some of the plurality of elements,
identifying second sub-attribute information of the element; and
replacing the element with a corresponding collection element to which the identified second sub-attribute information is applied.

11. The method of claim 9, wherein the replacing is not performed if the corresponding collection element is generated based on a plurality of elements included in a single element set.

12. The method of claim 1, further comprising:
receiving a default style of the design item;
obtaining a default attribute information set of at least one default element set corresponding to the component set; and
generating at least one generation style of the design item including a generation element set of a generative attribute information set, based on at least some of the default attribute information set,
wherein the first style and the at least one second style correspond to the default style or the at least one generation style.

13. The method of claim 12, wherein each of at least one piece of generative attribute information included in the generative attribute information set corresponds to one of:
first generative attribute information including first sub-attribute information of the default attribute information and second sub-attribute information that is different from second sub-attribute information of the default attribute information;
second generative attribute information including first sub-attribute information and second sub-attribute information that are configurable independently of the default attribute information; and
third generative attribute information corresponding to the default attribute information.

14. The method of claim 13, wherein, to the third generative attribute information, if there is a first change in the default attribute information, the first change is applied, and to the default attribute information, if there is a second change in the third generative attribute information, the second change is applied.

15. The method of claim 1, further comprising:
loading an attribute information list corresponding to a plurality of elements respectively included in the first element set and in the second element set; and
providing at least one piece of attribute information included in the attribute information list.

16. (canceled)

17. The method of claim 1, further comprising:
extracting at least some components, to which the first element is applied, from at least one component included in the component set; and
providing print layout data that is obtained by arranging the at least some components in raw material data corresponding to the first element.

18. The method of claim 17, further comprising:
calculating and providing a cost corresponding to the raw material data based on the print layout data.

19. A non-transitory computer-readable storage medium storing instructions that, when executed by one or more processors, cause the one or more processors to:
obtain, corresponding to a first style of a design item, a first attribute information set corresponding to a first element set associated with a component set included in the design item;
obtain, corresponding to a second style of the design item, a second attribute information set corresponding to a second element set associated with the component set, wherein each of the first element set and the second element set includes a first element in common, and each of the first attribute information set and the second attribute information set includes first attribute information corresponding to the first element; and
in response to user input to change the first attribute information to second attribute information in the first attribute information set, obtain a third style corresponding to the first style by applying the second attribute information to the first element of the first element set.

20. An apparatus for generating design data, the apparatus comprising:
memory; and
at least one processor connected to the memory,
wherein the memory stores instructions that, when executed by the at least one processor individually or collectively, cause the apparatus to perform:
obtain, corresponding to a first style of a design item, a first attribute information set corresponding to a first element set associated with a component set included in the design item;
obtain, corresponding to a second style of the design item, a second attribute information set corresponding to a second element set associated with the component set, wherein each of the first element set and the second element set includes a first element in common, and each of the first attribute information set and the second attribute information set includes first attribute information corresponding to the first element; and
in response to user input to change the first attribute information to second attribute information in the first attribute information set, obtain a third style corresponding to the first style by applying the second attribute information to the first element of the first element set.
